(19) United States
(12) Patent Application Publication
(10) Pub. No.: US 2020/0129876 A1
(43) Pub. Date: Apr. 30, 2020

(54) RETRACTABLE AIR INFLATABLE DISPLAY

(71) Applicant: Aqua-Leisure Industries, Inc., Avon, MA (US)

(72) Inventor: Gregory J. Autore, Spring Valley, OH (US)

(73) Assignee: Aqua-Leisure Industries, Inc., Avon, MA (US)

(21) Appl. No.: 16/573,543

(22) Filed: Sep. 17, 2019

Related U.S. Application Data
(60) Provisional application No. 62/733,114, filed on Sep. 19, 2018.

(51) Int. Cl. A63H 27/10; G09F 19/08

(52) U.S. Cl. CPC A63H 27/10; G09F 19/08; A63H 2027/1075; A63H 2027/1033; A63H 2027/1008

(57) ABSTRACT

A continuous-air-inflatable display includes an air blower to cause the air-permeable display body to rise from a container and then remain in its expanded state while air flows into the body. After the airflow is terminated, the body gradually collapses back into the container as the air escapes from the body. A motor-retracted cord attached to the display body assists in causing the display body to fall back into the container as the air in the body gradually escapes.

### RELATED APPLICATION

This application claims priority under 35 U.S.C. Section 119(e) to U.S. Provisional Application Ser. No. 62/733,114 entitled “RETRACTABLE AIR INFLATABLE DISPLAY,” filed on Sep. 19, 2018, which application is hereby incorporated by reference in its entirety for all purposes.

### SUMMARY OF THE INVENTION

This invention relates to continuous-air-inflatable displays, and particularly to a display construction that includes an air blower to cause the display body to rise from a container and then remain in its expanded state while air flows into the body. Once the airflow is terminated, the body gradually collapses back into the container. In one aspect of the invention, a motor-retracted cord attached to the display body assists in causing the display to fall back into the container as the air in the body gradually escapes.

### BACKGROUND OF THE INVENTION

Inflatable displays have become popular lawn and porch ornaments, particularly during the holiday seasons. Inflatable witches, monsters, and pumpkins appear at Halloween, Santa Claus and reindeer at Christmas, etc. An air blower provides a continuous flow of air into the body of the inflatable figure, which is constructed of an air permeable fabric. Once the body is filled with air, excess air escapes through the fabric at approximately the sat e ra e as the incoming flow of air, causing the figure to retain its inflated shape.

In one aspect of the instant invention, the inflatable figure may rise up out of a container as the air inflates the body of the figure When the air blower is de-activated, the body of the figure begins to gradually collapses as the air within the body escapes through the permeable fabric. In one aspect of the instant invention, a motor--retracted cord pulls the collapsing body back into the container from which it arose, rather than have the body collapse in an untidy and unsightly heap on someone's lawn or floor.

### DESCRIPTION OF THE DRAWINGS

FIGS. 1A-1D is a front view illustrating the gradual deflation of the inflatable body as it descends into its original container.

FIGS. 2A-2D is a side view illustrating the gradual deflation of the inflatable body as it descends into its original container.

FIG. 3 depicts the winding motor and its housing.

### DETAILED DESCRIPTION OF THE INVENTION

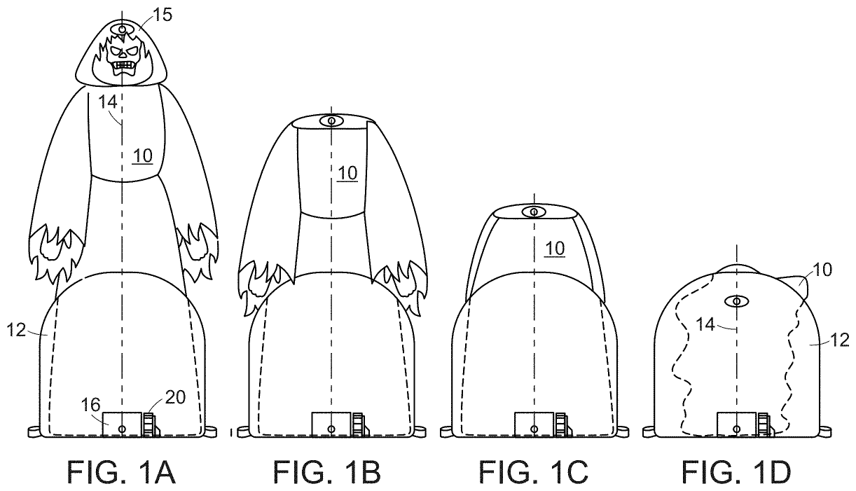

In one aspect of the instant invention, as shown in FIGS. 1A-1D, an inflatable body 10, which may depict a standing monster, rests in its uninflated state within container 12. Cord 14 may be affixed at one end to an upper portion of inflatable body 10, and at the other end to spindle 18 of an electric motor (not shown) that resides within housing 16. Housing 16 is located at the bottom of container 12 within body 10.

As the inflatable body 10 is inflated by an air blower 20, in conventional fashion, the air pressure building in the body causes body 10 to rise and cord 14 to unwind from spindle 18 of the electric motor, the motor having been disengaged from the spindle and deactivated while the air blower is activated.

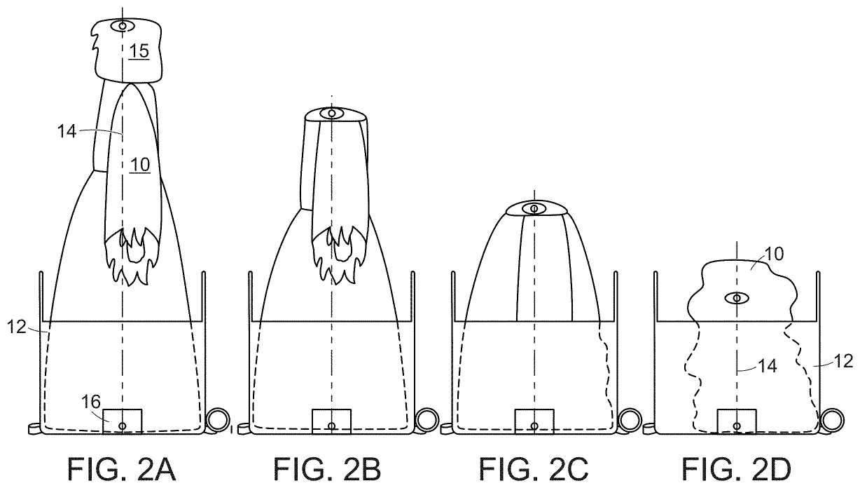

As illustrated in FIGS. 2A-2D, when the air blower 20 is turned off, the air pressure inside the inflatable body 10 begins to decrease as air escapes and the inflatable body begins to collapse. The electric motor is then activated and re-engaged to spindle 18, and it draws cord 14 downward to rewind around the spindle. As the air gradually escape from inflatable body 10, the body is pulled down by cord 14 and directed into container 12.

In one aspect of the invention, cord 14 is attached to the top portion 15 of inflatable body 10 so that he top portion 15 (see FIG. 1A) is the first portion of the body to be pulled down and into container 12—as illustrated in FIGS. 1A and 1B, where the top portion 15 has already been pulled down into inflatable body 15. This helps ensure that, as cord 14 continues to pull the top portion 15 downward, the remainder of inflatable body 10 falls within the confines of the container 12 as the body slowly deflates.

The air blower 20 and the electric motor ay be connected to a programmable timer that controls the amount of time that the air blower 20 is activated, the amount of time the electric motor is activated, and the sequencing of the blower and n or activation. For example, the timer may be programmed so that the air blower 20 is activated for, say, three minutes, and then the air blower is de-activated and the electric motor is activated until the deflated inflatable body 10 is resting within container 12. A switch may cause the electric motor to shut off once the cord 14 is entirely re-wound onto spindle 18. The tuner may then cause the cycle to repeat after a chosen period of time.

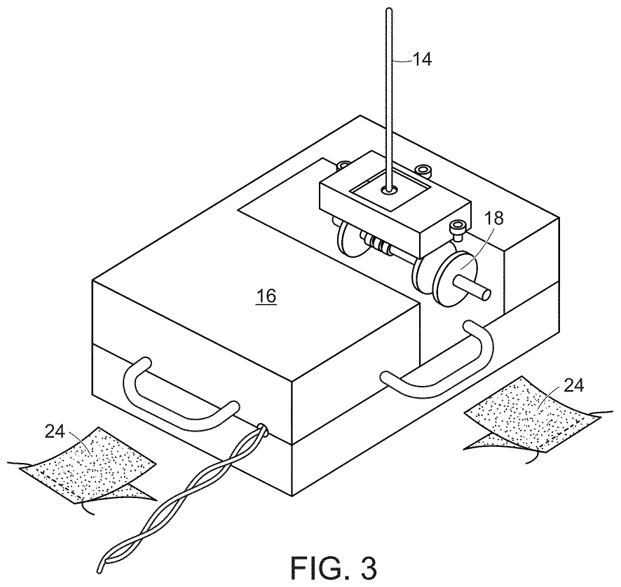

FIG. 3 depicts housing 16, which may be attached inside the inflatable body by, for example, hook-and-loop fasteners 22. Cord 14 winds and unwinds around spindle 18, as described above.

Because the retraction of inflatable body 10 into container 12 is accomplished with a cord and a winding motor, the instant invention avoids several problems that arise with prior devices that employ hard, telescoping rods, to retract a display figure—including the breaking, bending, or misalignment of the rods. Use of a cord allows the inflatable body to collapse into a much smaller space for end-of-season storage, which is one of key benefits of continuous-air inflatables.

The foregoing description of the invention is provided by way of example and is not intended to be limiting. Variations, alterations and modifications may occur to those skilled in the art, and they are intended to be within the spirit and scope of this disclosure.

What is claimed is:

1. An air inflatable display comprising:
an air permeable, inflatable body;
an air blower adapted to inflate said inflatable body;
a container in which the uninflated body rests;
a winding motor;
at least one cord attached at one end to the inflatable body and at the other end to the winding motor;
wherein as the inflatable body is being inflated by the air blower the cord is caused to unwind from the winding motor, and wherein when the air blower is not operating, the inflatable body deflates, and the winding motor rewinds the cord, thereby pulling the inflatable body back into the container.

2. The air inflatable display of claim 1, further comprising a programmable timer to allow selection of the amount of time during which each of the air blower and the winding motor is activated.
